(19) United States
(12) Patent Application Publication
(10) Pub. No.: US 2017/0032398 A1
(43) Pub. Date: Feb. 2, 2017

(54) METHOD AND APPARATUS FOR JUDGING AGE BRACKETS OF USERS

(71) Applicants: BEIJING JINGDONG SHANGKE INFORMATION TECHNOLOGY CO, LTD., Haidian District, Beijing (CN); BEIJING JINGDONG CENTURY TRADING CO., LTD., Beijing (CN)

(72) Inventors: Qingfeng LI, Haidian District, Beijing (CN); Chuan MOU, Haidian District, Beijing (CN)

(21) Appl. No.: 15/303,947

(22) PCT Filed: Apr. 17, 2015
(86) PCT No.: PCT/CN2015/076905

§ 371 Date: Oct. 13, 2016

(30) Foreign Application Priority Data
Apr. 18, 2014 (CN) 201410158028.8

(51) Int. Cl. G06Q 30/02; G06N 7/00; G06F 11/07; G06Q 10/06

(52) U.S. Cl. CPC G06Q 30/0204; G06Q 10/067; G06N 7/005; G06F 11/076; G06F 11/0721

(57) ABSTRACT

Method for judging age brackets of users including acquiring consumption data of users and establishing models based on the consumption data. Establishing the models includes dividing the consumption data into training data and test data, calculating a number of the users of the training data in predetermined age brackets, calculating a number of each tertiary category of the training data in the predetermined age brackets, calculating probabilities that each tuple of the test data belongs to each of the predetermined age brackets based on the number of the users and the number of the tertiary categories, selecting the age bracket with the maximum probability as the age bracket to which the user corresponding to the tuple belongs, comparing errors between the predetermined age brackets and the selected age bracket to obtain a predictive error rate, and outputting models with predictive error rates larger than or equal to a predetermined threshold.

### TECHNICAL FIELD

The invention relates to the intern& information analysis field, and specifically relates to a method and apparatus for judging age brackets of users.

### BACKGROUND ART

In recent years, the intern& develops rapidly, which brings great conveniences and benefits to people, and the people can perform activities such as entertainment, shopping, and making friends via the network. Websites also provide users with more comfortable and highly targeted servers through registration information of the users, but due to the virtuality of networks, many users are not willing to reveal personal information too much.

In order to improve the efficiency of the user registration time, age is not a required item, and even if very few persons fill in the information of this item, some persons handle with the item carelessly, so the information is not accurate, which results in a severe lack of such important data in a database. The reason that the age is the important information of a user is that users with different ages are very different in terms of living habits, attitudes to life and personal values, and as regarding to e-commerce, they are very different in terms of shopping habits. Thus, target marketing can be performed with respect to the users as long as the ages of the users are known well, thereby the adhesiveness of users are improved.

Since there are limited precious user age information, and there are certain errors, some persons filter the ages of the users with internet industry data and experiences to thereby obtain relatively accurate age data. Such method can only obtain the ages of part of the users, which are only the tip of the iceberg of a huge user group.

Relevant technical staff of the Tencent Inc. estimate the ages of the users on the basis of massive data. The method comprises: acquiring basic age data of the users, assigning the basic age data with an initial weighted value; acquiring age weighted values of the users in the different basic age data in accordance with the initial weighted value and age similarity of the users in the different basic age data; searching the age having the maximum age weight value in the basic age data, and using the age having the maximum age weight value as an initial estimated age of the users. Other prior arts relating to the invention mainly include: a Naive Bayes algorithm technique, a massive data processing technique, and a python programming technique.

The prior solution is to segment the ages of the users, i.e., age brackets of all the users are finally obtained. The disadvantage of such solution is that the granularity is comparatively coarse, which cannot finely describe the ages of the users.

Thus, a technical solution that can more accurately determine the ages of the users is needed.

### SUMMARY OF THE INVENTION

The object of the invention is to more accurately determine age brackets of users by analyzing consumption data of the users, thereby target marketing in accordance with characteristics of the age brackets is achieved.

In accordance with one embodiment of the invention, a method for determining age brackets of users on the basis of consumption data of the users is provided, the method comprising: acquiring a plurality of consumption data of a plurality of users; modeling on the basis of the acquired plurality of consumption data to establish models satisfying specific conditions, the modeling further comprising: dividing the consumption data into training data and test data; calculating the number of the users of the training data in a plurality of predetermined age brackets, calculating the number of each tertiary category of the training data in the plurality of predetermined age brackets, and calculating probabilities that each tuple of the test data belongs to each of the plurality of predetermined age brackets on the basis of the number of the users and the number of the tertiary categories; selecting the age bracket to which the maximum one of the probabilities belongs as the age bracket to which the user corresponding to the tuple belongs; comparing errors between the plurality of predetermined age brackets and the selected age bracket to obtain a predictive error rate, and outputting the models with the predictive error rates larger than or equal to a predetermined threshold; and calculating the age brackets of the users by utilizing the output models.

Preferably, the dividing the consumption data into training data and test data further comprises: segmenting the consumption data in accordance with the plurality of predetermined age brackets; and removing consumption data with the number of the tertiary categories smaller than a predetermined number from the consumption data.

Preferably, the proportion of the training data to the test data is 7:3.

Preferably, the predetermined threshold is 0.7.

Preferably, the method further comprises: selectively providing advertisements, recommendations, reports, notifications, messages, media or any combination thereof to the users on the basis of the selected age bracket.

According to another embodiment of the invention, an apparatus for determining age brackets of users on the basis of consumption data of the users is provided, the apparatus comprising: an input module for acquiring a plurality of consumption data of a plurality of users; a modeling module for modeling on the basis of the acquired plurality of consumption data to establish models satisfying specific conditions, the modeling module further comprising: a calculating module configured to divide the consumption data into training data and test data; calculate the number of the users of the training data in a plurality of predetermined age brackets; calculate the number of each tertiary category of the training data in the plurality of predetermined age brackets; and calculate probabilities that each tuple of the test data belongs to each of the plurality of predetermined age brackets on the basis of the number of the users and the number of the tertiary categories; a selecting module configured to select the age bracket to which the maximum one of the probabilities belongs as the age bracket to which the user corresponding to the tuple belongs; a comparing module configured to compare errors between the plurality of predetermined age brackets and the selected age bracket to obtain a predictive error rate, and output the models with the predictive error rates larger than or equal to a predetermined threshold; and an application module for calculating the age brackets of the users by utilizing the output models.

Preferably, the modeling module is further configured to: segment the consumption data in accordance with the plurality of predetermined age brackets; and remove consumption data with the number of the tertiary categories smaller than a predetermined number from the consumption data.

Preferably, the proportion of the training data to the test data is 7:3.

Preferably, the predetermined threshold is 0.7.

Preferably, the apparatus further compress: a presenting module for selectively providing advertisements, recommendations, reports, notifications, messages, media or any combination thereof to the users on the basis of the selected age bracket.

According to the solution of determining the age brackets of the users of the invention, the age brackets of the users can be exactly and automatically determined.

In accordance with detailed descriptions of the disclosure and figures below, other objects, features and advantages will be obvious to those skilled in the art.

### BRIEF DESCRIPTION OF THE DRAWINGS

Figures show embodiments of the invention, and are used for explaining the principle of the invention together with the Specification. In the figures:

FIG. 1 shows a view of an apparatus 100 for determining age brackets of users in accordance with the embodiment of the invention;

FIG. 2 shows a schematic diagram of a solution 200 for determining the age brackets of the users in accordance with the invention; and

FIG. 3 shows a flow chart of a method 300 for estimating the age brackets of the users on the basis of consumption data of the users in accordance with the embodiment of the invention.

### DETAILED DESCRIPTION

In accordance with the embodiment of the invention, a method and apparatus for determining age brackets of users is disclosed. In the descriptions below, for the purpose of explanations, multiple specific details are illustrated to provide overall understanding of the embodiments of the invention. However, it is obvious to those skilled in the art that the embodiments of the invention can be achieved without these specific details.

As mentioned above, applications and services to be provided to the users often depend on ages of the users, which serve as an important factor for providing efficient services. That is to say, the users with different ages may be interested in different services. For example, advertisements, contents, applications and the like are generally designed for audience with particular ages. For example, university students generally belong to a group of standard consumption, while adults generally belong to a group of household consumption. Thus, acquirement of age ranges of the users can facilitate the provision of customized services to the users. Moreover, relevant advertisements, contents and applications can be pushed to the users in relation to the ages, so that a user device does not bear massive loads of other information irrelevant to the age ranges of the users. In addition, some services require that the users are in a certain age bracket, and product information with respect to children with different ages need to aim at consumers having children in the corresponding age bracket.

The age bracket of the user can be determined by considering multiple aspects of the user. For example, the consumption data of the user during a specific time period can reflect the age bracket of the user. For example, a family having a child and a single person or a family not having a child have different consumption habits, and there are also differences among families having a child in different age brackets. Thus, the age bracket of the user can be estimated by analyzing the consumption data of the user.

For example, an analysis can be performed with respect to the consumption data of the user during a specific time period, for example the most recent year. The reason that the specific time period is selected as the most recent year is that the age of the user will increase as the passage of time, consumption characteristics in the most recent year reflect behavior habits in the current age, and the consumption habit of the user will correspondingly change along with the increasing of the age of the user, so consumption behaviors and characteristics during this age period can be actually reflected by taking a year as a unit. Certainly, in order to more exactly reflect a trend or change of the consumption characteristics in a specific age bracket, other time units, e.g., three months and six months, can be also used.

For example, in accordance with characteristics of the user using intern& and actual conditions of an e-commerce, the e-commerce can set a plurality of predetermined age brackets in a system, and each age bracket includes a specific age range. Alternatively, the age brackets can be also self-defined by the users. For example, the age brackets can be divided into the following five ones:
1^{st} bracket: 15-18 years old: a group without consumption capacity
2^{nd} bracket: 19-25 years old: single, in a group of standard consumption
3^{rd} bracket: 26-35 years old: a group of consumers having children in kindergartens
4^{th} bracket: 36-45 years old: a group of consumers having children in primary schools, junior middle schools and high schools
5^{th} bracket: 46-55 years old: a group of consumers having children in universities

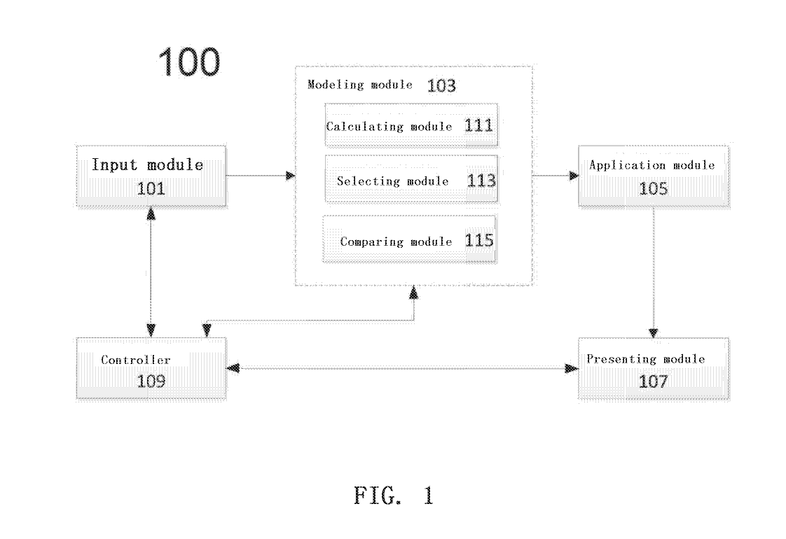

FIG. 1 shows a view of an apparatus 100 for determining age brackets of users in accordance with the embodiment of the invention. In FIG. 1, the apparatus 100 comprises an input module 101, a modeling module 103, an application module 105, a presenting module 107 and a controller 109. Those skilled in the art should understand that the functions of these modules can be combined in one or more assemblies or executed by other assemblies having equivalent functions.

In the embodiment, the input module 101 is used for inputting the consumption data of the users during a specific time period. The modeling module 103 is used for modeling with respect to the consumption data to establish models satisfying specific conditions. The application module 105 is used for estimating the age brackets of the users on the basis of the models established in the modeling module 103. The presenting module 107 is used for selectively providing advertisements, recommendations, reports, notifications, messages, media or any combination thereof to the users on the basis of the estimated age brackets. The controller 109 is used for monitoring tasks, including tasks executed by the input module 101, the modeling module 103, the application module 105 and the presenting module 107.

The modeling module 103 further comprises a calculating module 111, a selecting module 113 and a comparing module 115. The calculating module 111 can generate training data and test data on the basis of the input data, calculate the number of the users of the training data in a plurality of predetermined age brackets, and calculate the number of each tertiary category of the training data in the plurality of predetermined age brackets. Then, the calculating module 111 calculates probabilities that each tuple of the test data belongs to each of the plurality of predetermined age brackets on the basis of the number of the users and the number of the tertiary categories. The selecting module 113 selects the age bracket to which the maximum one of the probabilities belongs as the age bracket to which the user corresponding to the tuple belongs. The comparing module 115 is used for comparing errors between the known age brackets and the selected age bracket in the test data to obtain a predictive correct rate. The modeling module 103 outputs the models with the predictive correct rates larger than or equal to a predetermined threshold, and preferably outputs the models with the predictive correct rates larger than or equal to 0.7.

The application module 105 calculates the age brackets of the users by utilizing the models output from the modeling module 103, and presents a calculation result to the presenting module 107.

In accordance with the embodiment of the invention, the Naive Bayes algorithm is introduced when the modeling module 103 determining the age brackets of the users. The Naive Bayes algorithm is a probability categorization algorithm, which, with respect to a given item to be categorized, solves probabilities of occurrence of respective categories in a case that the item occurs on the basis of a simple categorization idea, and the item to be categorized is considered to belong to the category having the maximum probability of occurrence. For example, if the probabilities of occurrence of the specific user in a plurality of age brackets set by the e-commerce is determined, the age bracket in which the maximum probability occurs is the age bracket to which the specific user belongs.

Specific explanations of the Naive Bayes algorithm are as follows:

(1) D is assumed to be a set of training tuples and associated category labels. As a rule, each tuple is expressed by one n-dimensional attribute vector X={x1, x2 . . . , xn}, which describes n measurements of the tuple by n attributes A1, A2, . . . , An.

(2) It is assumed that there are m categories C1, C2, . . . Cm. The tuple X is given, and a categorization method will predict that X belongs to the category having the highest posterior probability (under the condition X). That is to say, the Naive Bayes categorization method predicts that X belongs to a category Ci, when and only when P(Ci|X)>P(Cj|X) j>=1 and j<=m, j!=i. According to the Naive Baye theorem, P(Ci|X)=P(X|Ci)*P(Ci)/P(X).

(3) Since P(X) is a constant with respect to all the categories, it is satisfied as long as P(X|Ci)*P(Ci) is maximized.

(4) P(Ci)=|C_{i,D}|/|D|, where |C_{i,D}| is the number of the training tuples of the category Ci in D, and |D| is the number of all of the tuples in D.

P(X|Ci)=πⁿₖ₋₁P(x1|Ci)*P(x2|Ci)* . . . *P(xn|Ci). (5)

Xk includes two circumstances, i.e., a categorization attribute and a continuous attribute, and it is the category attribute in this model, and if it is the category attribute, P(xk|Ci)=(the number of the tuples that the value of an attribute Ak is xk in Ci)/(the number of the tuples of Ci in D).

The categorization generally includes the following two steps: establishment of models and application of models.

Firstly, a model is established with respect to a data set whose category has been determined. The data set for establishing the model is called a training set, and a single tuple in the training set is called a training sample. Each tuple in the training set belongs to a determined category, and the category is expressed by a category label. A study model is provided in a form of a categorization rule or a mathematical formula. In practice, sample data whose category has been known is used as the training set, and a rule relating to the categorization is obtained by studying the training set, thereby new data is categorized.

Secondly, the established models are used to classify tuples whose categories are not known into one or several categories. The use of the models to perform the categorization requires the estimation of the predictive correct rate of the categorization models. There are many estimating methods, and generally the established models is used to perform prediction in one test set, and compare the result with an actual value to obtain the predictive correct rate, wherein the test set being independent of the training set. the “test set” as used herein refers to an independent sample set for estimating abilities such as prediction of the models that has not been used when designing an identification and categorization system so as to validate the models.

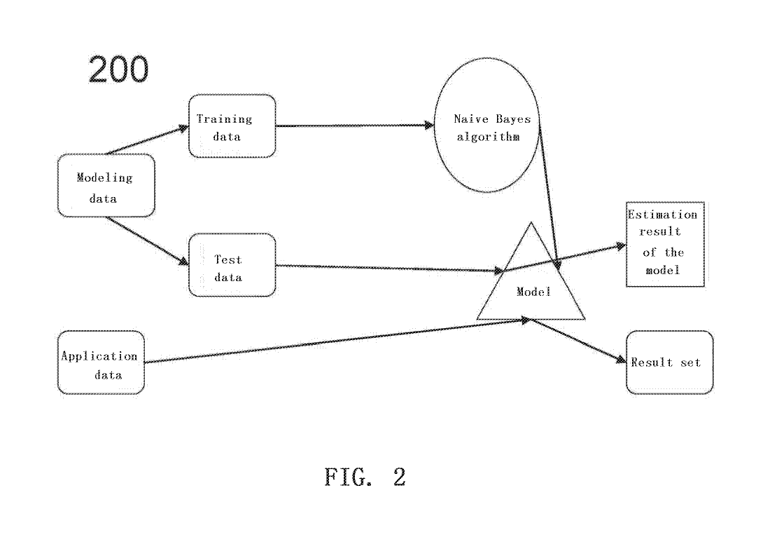

For example, FIG. 2 shows a schematic diagram of a solution 200 for determining the age brackets of the users in accordance with the invention. The solution for determining the age brackets of the users mainly includes two parts, i.e., model establishment and model application, wherein the model establishment includes: dividing modeling data into training data and test data (the proportion is 7:3), the training data generate a Bayes model through the Naive Bayes algorithm, the test data estimate the qualities of the models through the Bayes models, and comparatively good models are finally obtained by continuously adjusting features and categorization labels. The model application includes: for example, predicting all of the user data satisfying the model characteristics through the models to finally obtain massive data of the age brackets of the users. Finally determined data features are as follows: consumption data of tertiary categories of the user in the most recent year, and the specific modeling data can be shown in Table 1 below:

TABLE 1
Modeling data of age models

| User | Age | Tertiary | Tertiary | Tertiary | Tertiary | |
|---|---|---|---|---|---|---|
| id | bracket | category | category | category | category | . . . |
| | | 1 | 2 | 3 | 4 | |

### Specific Implementation Solution

### 1. Input of Data Set

In one embodiment, methods and steps for inputting the data set are as follows:

1) Convert the tertiary categories of consumer goods of the same user into one row to adapt to an input format of the algorithm, as shown below:

The format of the input data is as shown in Table 2:

TABLE 2
Modeling source data of age models

| | | | Tertiary |
|---|---|---|---|
| Field | User account | Birthday | category |
| eg: | fengguoying | 1985 Sep. 24 | 685 |
| | fengguoying | 1985 Sep. 24 | 4833 |

The format of the output data is as shown in Table 3:

TABLE 3
Modeling data of age models (Put the tertiary categories
of the same person in one row)

| | User | | Tertiary | Tertiary | |
|---|---|---|---|---|---|
| Field | account | Birthday | category 1 | category 2 | . . . |
| eg: | fengguoying | 1985 Sep. 24 | 4833 | 655 | . . . |

2) The modeling data are segmented in accordance with the plurality of predetermined age brackets set by the e-commerce, and meanwhile user purchase data with the number of the tertiary categories of the purchased goods smaller than a specific number (4 in the embodiment) are removed to reduce an estimation error.

The format of the input data is as shown in Table 4:

TABLE 4
Modeling data of age models (Put the tertiary categories
of the same person in one line)

| | User | | Tertiary | Tertiary | |
|---|---|---|---|---|---|
| Field | account | Birthday | category 1 | category 2 | . . . |
| eg: | fengguoying | 1985 Sep. 24 | 4833 | 655 | . . . |

The format of the output data is as shown in Table 5:

TABLE 5
Modeling data of age models (converting the birthday
into the age, and meanwhile performing the segment)

| | | Tertiary | Tertiary | |
|---|---|---|---|---|
| Field | Age bracket | category 1 | category 2 | . . . |
| eg: | 3 | 4883 | 655 | . . . |

### 2. Training Set and Test Set

In the selected data set, the data are divided into the training data and the test data in the proportion of 7:3. Modeling is performed using the training data, and the models are estimated using the test data.

### 3. Determination of Age Brackets

In accordance with the embodiment of the invention, the age brackets of the users are estimated based on the training data and the test data in accordance with the following steps:

(1) Calculate the number of the users of the training data in the categories of the respective age brackets. Specifically, calculate the number of the users |Ci| of D_Train in the respective age brackets.

(2) Calculate the number of each tertiary category of the training data in the respective categories. Specifically, calculate the number of each tertiary category |xk/Ci| of D_Train in the respective age brackets.

(3) Calculate probabilities that each tuple of the test data belongs to the respective age brackets in accordance with the data obtained in the above two steps. Specifically, obtain probabilities that each person of D_Test belongs to the respective age brackets in accordance with prior probabilities in the above two steps P(X|Ci)=P(x1|Ci)*P(x2|Ci)* . . . *P(xn|Ci).

(4) Select the category of the age bracket having the maximum probability that a certain tuple in the test data belongs to the respective categories as the category to which the user of the tuple belongs. Specifically, select the age bracket corresponding to the maximum probability that each person in D_Test belongs to the respective age brackets as the age bracket to which the user belongs. X belongs to Cj, when and only when P(X/Cj)=max(P(X/Ci))i=1, 2 . . . 6.

(5) Compare errors between the known age brackets and the selected age bracket in the test data. Compare errors between each of the known age brackets and the selected age bracket in D_Test to obtain the correctly predicted users D_Test_Correct, and obtain a predictive correct rate=D_Test_Correct|/|D_Test|.

(6) Repeat the above steps to calculate the age brackets of all of the users. Specifically, if the correct rate>=0.7, the models are used to calculate the age brackets of the users, otherwise a stop is performed; the age brackets of all of the users D_All are calculated in accordance with the models, and the methods are the same as those in the steps in (3) and (4).

In addition, the estimation of the models can be performed in accordance with the following standards: (1) predication accuracy rate; (2) establishment speed and use speed of the models; (3) robustness; (4) adaptability of the models to data having noises or missing values; (5) scalability; (6) adaptability of the models when the data increase enormously; and (7) interpretability, i.e., a degree of understandability of the models. For example, in accordance with the technical solution of the invention, the predictive correct rate is 70% or higher; the algorithm is very efficient, and predictions of 30,000,000 users can be completed within 5 minutes.

The e-commerce can selectively providing advertisements, recommendations, reports, notifications, messages, media or any combination thereof to the users on the basis of the calculated age brackets of the users.

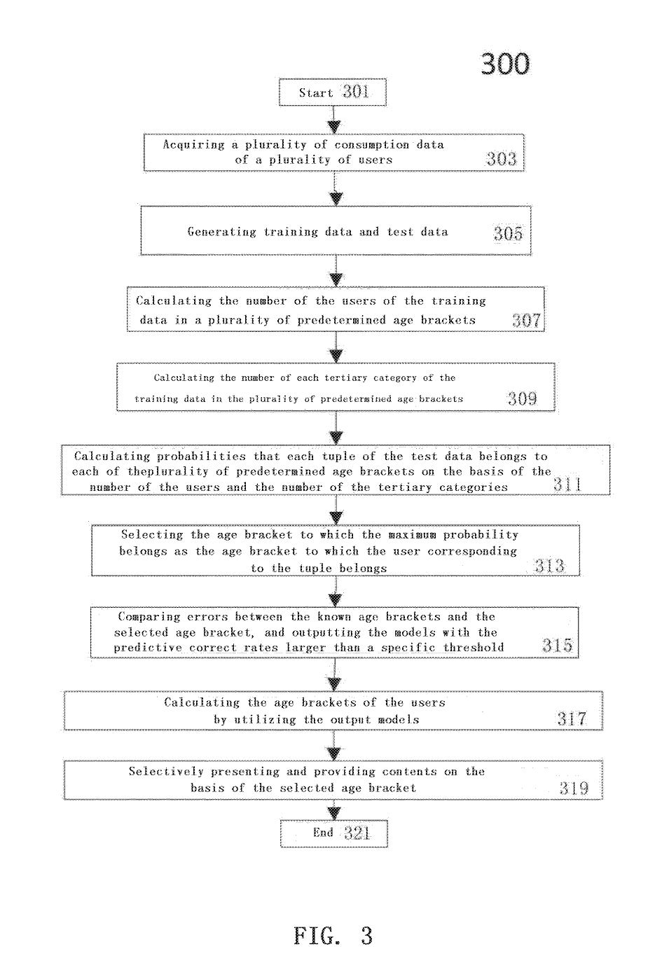

FIG. 3 shows a flow chart of a method 300 for estimating the age brackets of the users on the basis of consumption data of the users in accordance with the embodiment of the invention.

As shown in FIG. 3, the method 300 starts in the step 301. In the step 303, the input module 101 acquires a plurality of consumption data of a plurality of users. In the step 305, the calculating module 111 generates training data and test data. In the step 307, the calculating module 111 calculates the number of the users of the training data in a plurality of predetermined age brackets. In the step 309, the calculating module 105 calculates the number of each tertiary category of the training data in the plurality of predetermined age brackets, then in the step 311, the calculating module 105 calculates probabilities that each tuple of the test data belongs to each of the plurality of predetermined age brackets on the basis of the number of the users and the number of the tertiary categories. In the step 313, the selecting module 113 selects the age bracket to which the maximum one of the probabilities belongs as the age bracket to which the user corresponding to the tuple belongs. In the step 315, the comparing module 115 compares errors between the known age brackets and the selected age bracket in the test data to obtain a predictive correct rate, and outputs the models with the predictive correct rates larger than a specific threshold. In the step 317, the application module 105 calculates the age brackets of the users by utilizing the models output from the modeling module 103, and outputs a calculation result to the presenting module 107. Thus, in the step 319, the presenting module 107 selectively presents contents such as advertisements, recommendations, reports, notifications, messages, media or any combination thereof to the users on the basis of the selected age bracket. The method 300 ends in the step 321.

The technical solution for determining the age brackets of the users in accordance with the embodiment of the invention can make the e-commerce determine the age brackets of the registered users in a more accurate and simple manner, e.g., the predictive correct rate can reach 70%. Thus, the e-commerce such as JINGDONG Inc. make customized services, contents, communications (e.g., marketing and advertisements) and the like be associated with the users more effectively in accordance with the age brackets of the users to thereby enable target marketing, which provides a powerful support. Meanwhile, regarding to the users accessing websites of these e-commerce, the user experience are remarkably enhanced and convenient personalized services are provided.

The above embodiments are only preferred embodiments of the invention, and are not used to limit the invention. It is obvious to those skilled in the art that various amendments and changes can be made to the embodiments of the invention without departing from the spirit and scope of the invention. Thus, the invention is intended to cover all of amendments or transformations falling within the scope of the invention as defined in the claims.

1. A method for determining age brackets of users on the basis of consumption data of the users, comprising:
acquiring a plurality of consumption data of a plurality of users;
modeling on the basis of the acquired plurality of consumption data to establish models satisfying specific conditions, the modeling further comprising:
dividing the consumption data into training data and test data; calculating the number of the users of the training data in a plurality of predetermined age brackets, calculating the number of each tertiary category of the training data in the plurality of predetermined age brackets, and calculating probabilities that each tuple of the test data belongs to each of the plurality of predetermined age brackets on the basis of the number of the users and the number of the tertiary categories;
selecting the age bracket to which the maximum one of the probabilities belongs as the age bracket to which the user corresponding to the tuple belongs;
comparing errors between the plurality of predetermined age brackets and the selected age bracket to obtain a predictive error rate, and outputting the models with the predictive error rates larger than or equal to a predetermined threshold; and
calculating the age brackets of the users by utilizing the output models.

2. The method according to claim 1, wherein the dividing the consumption data into training data and test data further comprises:
segmenting the consumption data in accordance with the plurality of predetermined age brackets; and
removing consumption data with the number of the tertiary categories smaller than a predetermined number from the consumption data.

3. The method according to claim 1, wherein a proportion of the training data to the test data is 7:3.

4. The method according to claim 1, wherein the predetermined threshold is 0.7.

5. The method according to claim 1, further comprising:
selectively providing advertisements, recommendations, reports, notifications, messages, media or any combination thereof to the users on the basis of the selected age bracket.

6. An apparatus for determining age brackets of users on the basis of consumption data of the users, comprising:
an input module for acquiring a plurality of consumption data of a plurality of users;
a modeling module for modeling on the basis of the acquired plurality of consumption data to establish models satisfying specific conditions, the modeling module further comprising:
a calculating module configured to divide the consumption data into training data and test data; calculate the number of the users of the training data in a plurality of predetermined age brackets; calculate the number of each tertiary category of the training data in the plurality of predetermined age brackets; and calculate probabilities that each tuple of the test data belongs to each of the plurality of predetermined age brackets on the basis of the number of the users and the number of the tertiary categories;
a selecting module configured to select the age bracket to which the maximum one of the probabilities belongs as the age bracket to which the user corresponding to the tuple belongs;
a comparing module configured to compare errors between the plurality of predetermined age brackets and the selected age bracket to obtain a predictive error rate, and output the models with the predictive error rates larger than or equal to a predetermined threshold; and
an application module for calculating the age brackets of the users by utilizing the output models.

7. The apparatus according to claim 6, wherein the calculating module is further configured to:
segment the consumption data in accordance with the plurality of predetermined age brackets; and
remove consumption data with the number of the tertiary categories smaller than a predetermined number from the consumption data.

8. The apparatus according to claim 6, wherein a proportion of the training data to the test data is 7:3.

9. The apparatus according to claim 6, wherein the predetermined threshold is 0.7.

10. The apparatus according to claim 6, further comprising:
a presenting module for selectively providing advertisements, recommendations, reports, notifications, messages, media or any combination thereof to the users on the basis of the selected age bracket.
